(19) United States
(12) Patent Application Publication
(10) Pub. No.: US 2020/0292035 A1
(43) Pub. Date: Sep. 17, 2020

(54) UNLOCKING MECHANISM FOR A VARIABLE CAMSHAFT PHASER

(71) Applicant: BorgWarner Inc., Auburn Hills, MI (US)

(72) Inventors: Mark M. Wigsten, Lansing, NY (US); Jonas Adler, Salt Lake City, UT (US)

(21) Appl. No.: 16/888,328

(22) Filed: May 29, 2020

Related U.S. Application Data
(60) Provisional application No. 62/855,239, filed on May 31, 2019.

(51) Int. Cl. F16H 21/06; F01L 1/34; F16H 21/04

(52) U.S. Cl. CPC F16H 21/06; F01L 2001/34459; F16H 21/04; F01L 1/34

(57) ABSTRACT

A vane phaser with an unlocking and relocking mechanism attached to the lock pin, which through the use of a solenoid, distinct from the solenoid used for the oil control valve, which can lock and unlock the vane phaser. When the solenoid is energized and during rotation of the camshaft, the solenoid makes contact with a lever or gear wheel attached to the lock pin, causing the lock pin to rotate. A helical feature on the lock pin itself or on the lever causes the lock pin to move axially, unlocking the vane phaser.

### REFERENCE TO RELATED APPLICATIONS

This application claims one or more inventions which were disclosed in Provisional Application No. 62/855,239, filed May 31, 2019, entitled “UNLOCKING MECHANISM FOR A VARIABLE CAMSHAFT PHASER”. The benefit under 35 U.S.C. § 119(e) of the United States provisional application is hereby claimed, and the aforementioned application is hereby incorporated herein by reference.

### BACKGROUND OF THE INVENTION

### Field of the Invention

The invention pertains to the field of variable cam timing. More particularly, the invention pertains to an unlock mechanism for a variable camshaft timing phaser.

### Description of Related Art

Internal combustion engines have employed various mechanisms to vary the relative timing between the camshaft and the crankshaft for improved engine performance or reduced emissions. The majority of these variable camshaft timing (VCT) mechanisms use one or more “vane phasers” on the engine camshaft (or camshafts, in a multiple-camshaft engine). Vane phasers have a rotor assembly with one or more vanes, mounted to the end of the camshaft, surrounded by a housing assembly with the vane chambers into which the vanes fit. It is possible to have the vanes mounted to the housing assembly, and the chambers in the rotor assembly, as well. The housing's outer circumference forms the sprocket, pulley or gear accepting drive force through a chain, belt, or gears, usually from the crankshaft, or possible from another camshaft in a multiple-cam engine.

Apart from the camshaft torque actuated (CTA) variable camshaft timing (VCT) systems, the majority of hydraulic VCT systems operate under two principles, oil pressure actuation (OPA) or torsional assist (TA). In the oil pressure actuated VCT systems, an oil control valve (OCV) directs engine oil pressure to one working chamber in the vane phaser while simultaneously venting the opposing working chamber defined by the housing assembly, the rotor assembly, and the one or more vanes. This creates a pressure differential across one or more of the vanes to hydraulically push the vane phaser in one direction or the other. Neutralizing or moving the oil control valve to a null position puts equal pressure on opposite sides of the one or more vanes and holds the vane phaser in any intermediate position. If the vane phaser is moving in a direction such that valves of the engine will open or close sooner, the vane phaser is said to be advancing and if the vane phaser is moving in a direction such that valves will open or close later, the vane phaser is said to be retarding.

The torsional assist (TA) systems operates under a similar principle with the exception that it has one or more check valves to prevent the vane phaser from moving in a direction opposite than being commanded, should it incur an opposing force such as torque.

The problem with OPA or TA systems is that the oil control valve defaults to a position that exhausts all the oil from either the advance or retard working chambers and fills the opposing chamber. In this mode, the vane phaser defaults to moving in one direction to an extreme stop where a lock pin engages, locking the movement of the rotor assembly relative to the housing assembly. The OPA or TA systems are unable to direct the vane phaser to any other position during the engine start cycle when the engine is not developing any oil pressure. This limits the vane phaser to being able to move in one direction only in the engine shut down. In the past this was acceptable because at engine shut down and during engine start the vane phaser would be commanded to lock at one of the extreme travel limits (either full advance or full retard).

Most engines with an intake phaser place the phaser in the retard position in engine shutdown using a lock pin or a series of lock pins, in preparation for the next start of a “stop-start mode” which automatically stops and automatically restarts the internal combustion engine to reduce the amount of time the engine spends idling when the vehicle is stopped, for example at a stop light or in traffic. This stopping of the engine is different than a “key-off” position or manual stop via deactivation of the ignition switch in which the user of the vehicle shuts the engine down or puts the car in park and shuts the vehicle off. In “stop-start mode”, the engine stops as the vehicle is stopped, then automatically restarts in a manner that is nearly undetectable to the user of the vehicle. In the past, vehicles have been designed primarily with cold starts in mind, since that is the most common situation. In a stop-start system, because the engine had been running until the automatic shutdown, the automatic restart occurs when the engine is in a hot state. It has long been known that “hot starts” are sometimes a problem because the engine settings necessary for the usual cold start—for example, a particular valve timing position—are inappropriate to a warm engine.

Unlocking the lock pin is dependent upon engine oil pressure available at start up.

### SUMMARY OF THE INVENTION

A vane phaser with an unlocking and relocking mechanism coupled to the lock pin, which through the use of at least one solenoid can lock and unlock the vane phaser. The at least one solenoid associated with the lock pin is distinct from the solenoid used for the phaser control valve. When the at least one solenoid is energized and during rotation of the camshaft, the at least one solenoid pin makes contact with a lever attached to the lock pin, causing the lock pin to rotate. A helical feature on the lock pin itself or on the lever causes the lock pin to move axially, unlocking the phaser.

Since the mechanism is mechanical and is not dependent upon oil engine pressure, the vane phaser can be unlocked at any time the camshaft is rotating. The advantage of being independent of engine oil pressure is that the vane phaser can be unlocked prior to oil pressure build up, which can be an issue in vane phasers. Furthermore, by unlocking the vane phaser to allow early phasing, engine emissions and engine vibration can be reduced during engine startup.

A lock pin assembly received within a rotor assembly or housing assembly of a vane phaser. The lock pin comprising: a body having a first closed head end, a second end and a recessed portion between the first closed head end and the second end, a shaft having a first end and a second end, the first end attached to the second surface of the second end of the body and a second end connected to a gear having at least one tooth; a spring surrounding the shaft and adjacent the second surface of the second end of the body for biasing the first closed head end towards the recess of the housing assembly; and a pin having a first end spring biased towards the at least two axially extending grooves in the recessed portion, the pin being perpendicular to the body of the lock pin. The first closed head end having a first surface for mating with the recess of the housing assembly, and a second surface adjacent the recessed portion; the second end of the body has a first surface adjacent the recessed portion and a second surface, the first surface of the second end of the body comprising at least two repeats of a sequence of a first radiused edge, a flat, and a second radiused edge. The recessed portion is defined between the second surface of the first closed and the first surface of the second end of the body and has at least a first axially extending groove and a second axially extending groove, the first and second axially extending grooves each aligned with the flats of the first surface of the second end of the body.

### BRIEF DESCRIPTION OF THE DRAWING

FIG. 1 shows a front view of a phaser of a first embodiment with a single solenoid pin and a lock pin in the locked position.

FIG. 2 shows a front view of a phaser of the first embodiment with a single solenoid pin, with the lock pin moving between the locked position and unlocked position.

FIG. 3 shows a front view of a phaser of the first embodiment with a single solenoid pin and the lock pin in the unlocked position.

FIG. 4 shows an isometric view of a lock pin in the locked position and the position of the pin and the solenoid pin.

FIG. 5 shows a cutaway of the phaser showing the lock pin and solenoid pin in the locked position.

FIG. 6 shows a sectional view of the phaser with the lock pin in the locked position.

FIG. 7 shows an isometric view of a lock pin in the unlocked position and the position of the pin and the solenoid pin.

FIG. 8 shows a cutaway of the phaser showing the lock pin and the solenoid pin in the unlocked position.

FIG. 9 shows a sectional view of the phaser with the lock pin in the unlocked position.

FIG. 10 shows a lock pin between a locked and unlocked position and the position of the solenoid pin and the pin.

FIG. 11 shows a cutaway of the phaser moving between the locked and unlocked position.

FIG. 12 shows a sectional view of the phaser with the lock pin being between locked and unlocked.

FIG. 13 shows a sectional view of the phaser just prior to the locked position.

FIG. 14 shows sectional view of the detent on the lock pin.

FIG. 15 shows a front view of a phaser of the second embodiment with dual solenoid pins and the lock pin in the locked position.

FIG. 16 shows a front view of a phaser of the second embodiment with dual solenoid pins, with the lock pin moving between the locked position and unlocked position.

FIG. 17 shows a front view of a phaser of the second embodiment with dual solenoid pins and the lock pin in the unlocked position.

FIG. 18 shows a sectional view of the phaser with the lock pin in the locked position.

FIG. 19 shows a sectional view of the phaser with the lock pin in between a locked and an unlocked position.

FIG. 20 shows a sectional view of the phaser with the lock pin in the unlocked position.

FIG. 21 shows a sectional view of the phaser with the lock pin just prior to the locked position.

FIG. 22 shows a sectional view of the detent on the lock pin.

FIG. 23 shows an isometric view of a lock pin in a locked position and the position of the pin and the solenoid pin.

FIG. 24 shows an isometric view of a lock pin between a locked and an unlocked position and the position of the solenoid pin and pin.

FIG. 25 shows an isometric view of a lock pin in an unlocked position and the position of the solenoid pin and pin.

FIG. 26 shows an isometric view of the lock pin just prior to a locked position and the position of the pin and solenoid pin.

FIG. 27 shows a front view of a phaser with the lock pin in the unlocked position.

FIG. 28 shows a front view of the phaser relocking the lock pin.

### DETAILED DESCRIPTION OF THE INVENTION

In an embodiment of the present invention, rotation of the camshaft and a linear solenoid is used to mechanically lock and unlock a lock pin by changing rotational energy to linear energy, therefore circumventing hydraulic issues at startup of the engine and addressing immediate phasing needs of a vane phaser at startup without relying on hydraulic fluid to unlock the lock pin.

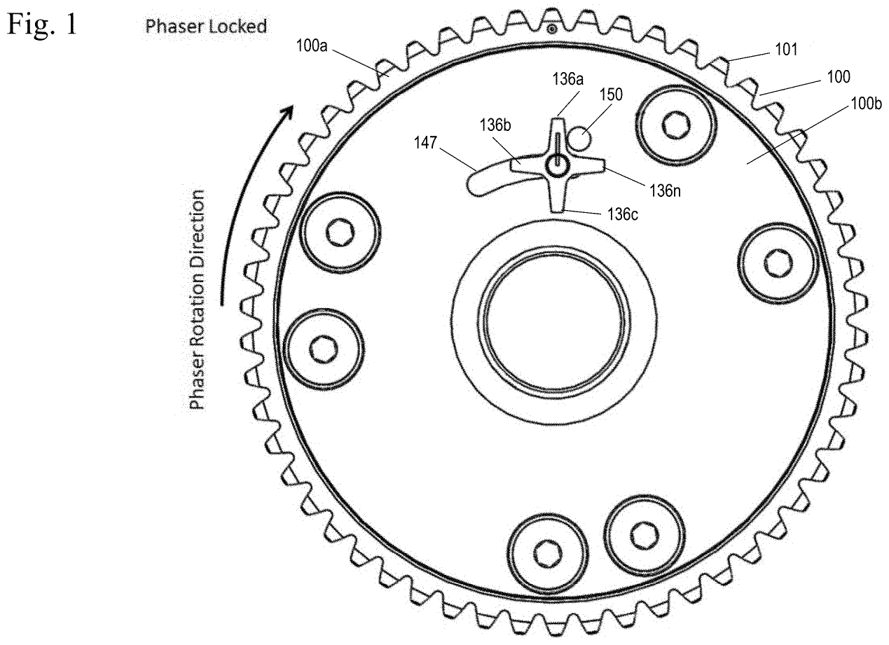

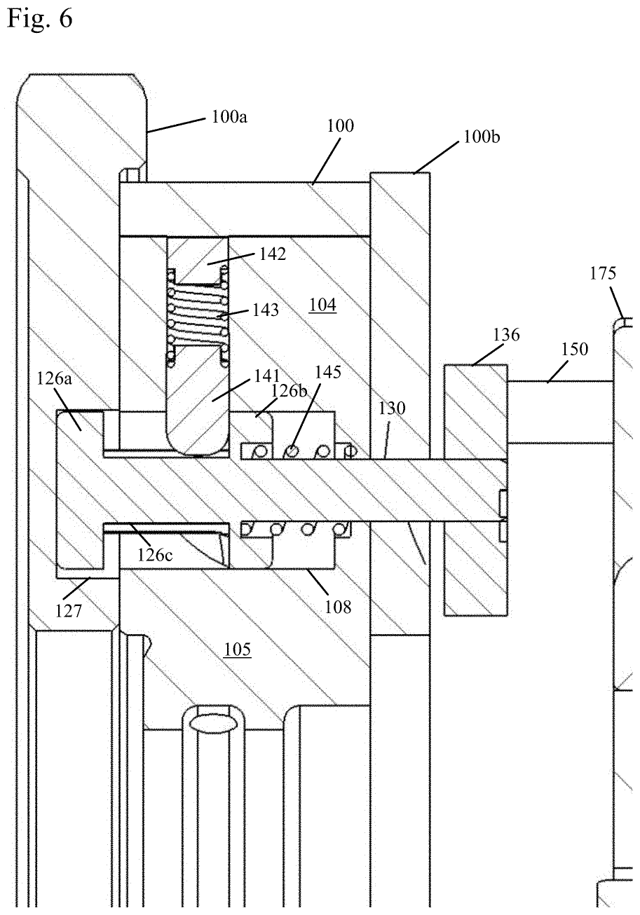

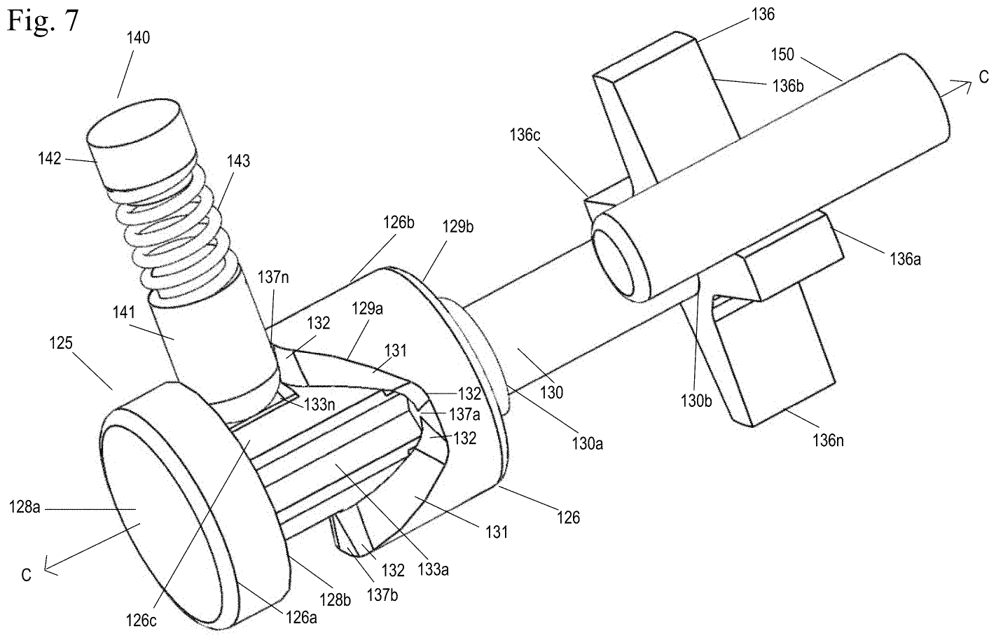

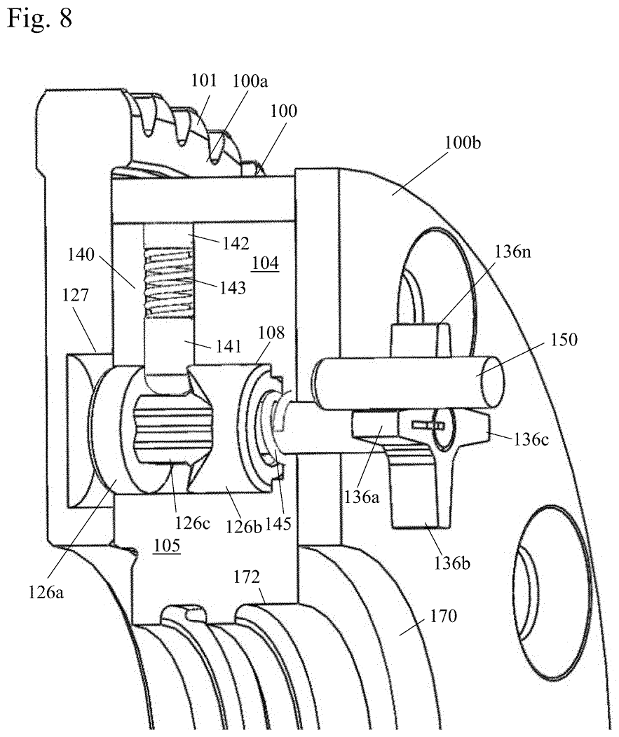

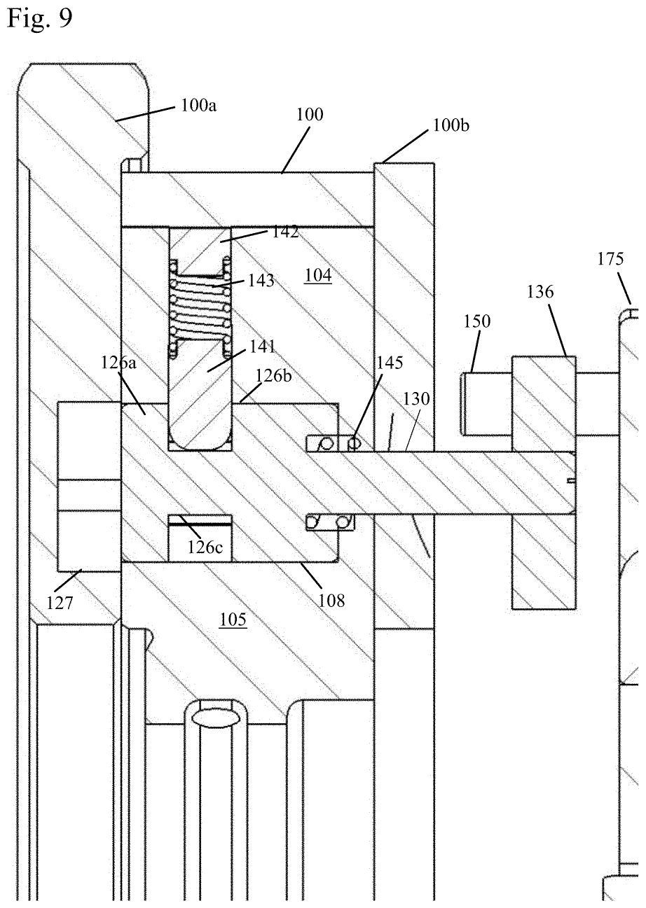

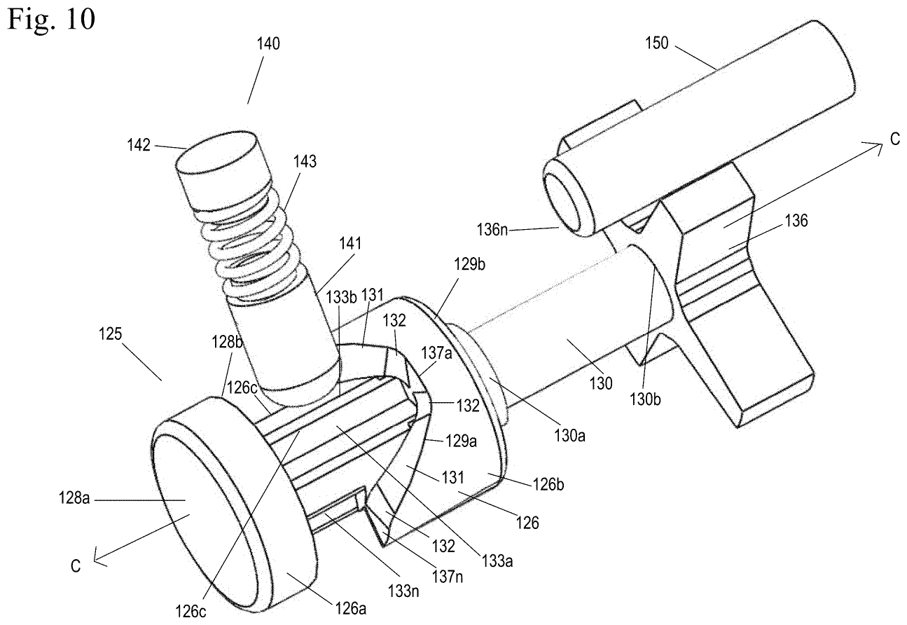

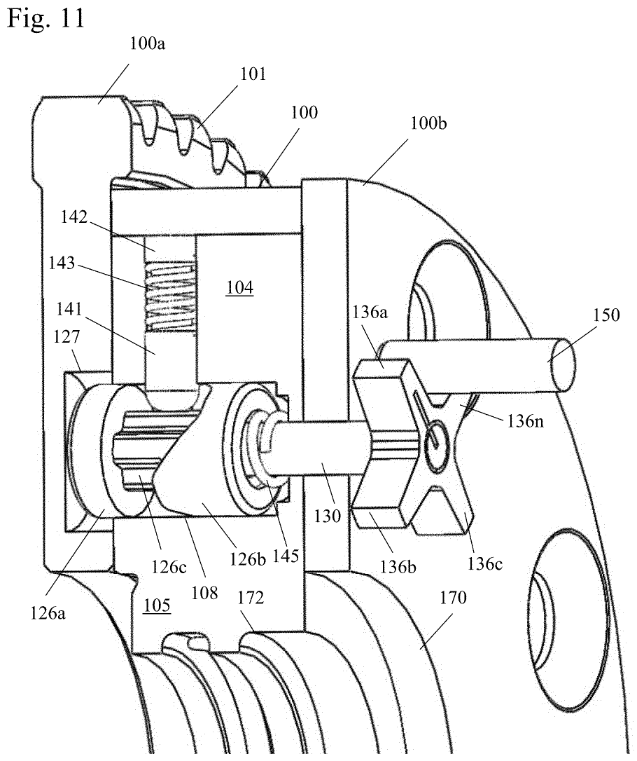

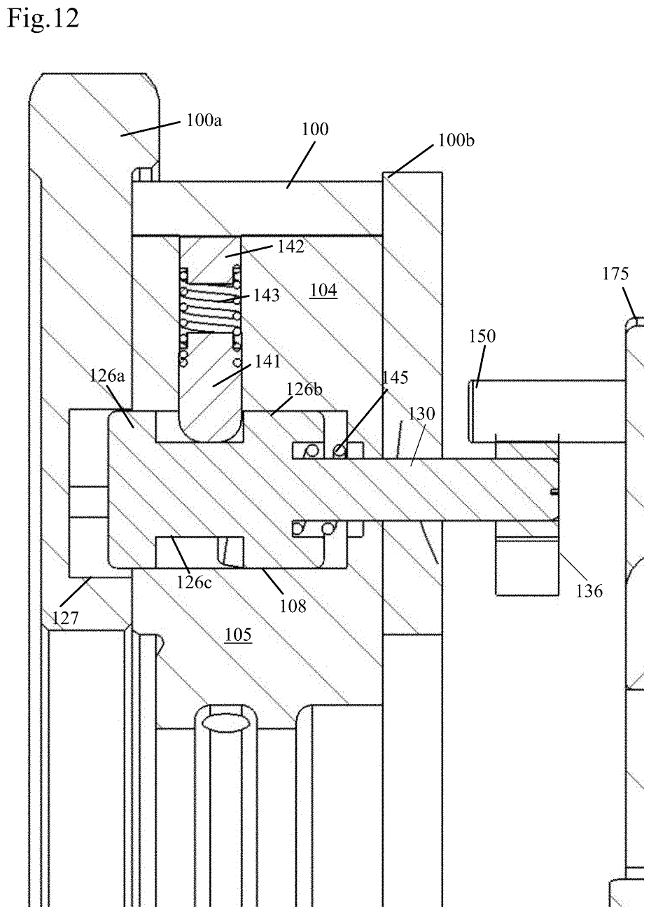

Referring to FIGS. 1-14, vane phasers (herein referred to as “phasers”) have a rotor assembly 105 with one or more vanes 104, mounted to the end of the camshaft (not shown), surrounded by a housing assembly 100 with vane chambers 171 into which the vanes 104 fit. It is possible to have the vanes 104 mounted to the housing assembly 100, and the chambers in the rotor assembly 105, as well. The housing assembly 100 includes a first end plate 100a and a second end plate 100b. The first end plate 100a has an outer circumference 101 which forms the sprocket, pulley or gear accepting drive force through a chain, belt, or gears, usually from the crankshaft, or possible from another camshaft in a multiple-cam engine.

The rotor assembly 105 is connected to the camshaft (not shown) and is coaxially located within the housing assembly 100. The rotor assembly 105 has a vane 104 separating a chamber 171 formed between the housing assembly 100 and the rotor assembly 105 into an advance chamber and a retard chamber. The vane 104 is capable of rotation to shift the relative angular position of the housing assembly 100 and the rotor assembly 105.

An oil control valve 170 can be located remotely from the phaser, within a bore 172 in the rotor assembly 105 which pilots in the camshaft, or in a center bolt of the phaser and controls the movement of the vane 104 to control the timing of the engine.

Within at least one vane 104 of the rotor assembly 105 is a lock pin 125. The lock pin 125 is slidably housed in a bore 108 of at least one vane 104 of the rotor assembly 105. The lock pin 125 is moveable from a first locked position in which the lock pin 125 engages a recess 127 in a first end plate 100a of the housing assembly 100, preventing movement of the rotor assembly 105 relative to the housing assembly 100 and an unlocked position in which the lock pin 125 does not engage the recess 127 in the first end plate 100a of the housing assembly 100 and the rotor assembly 105 can rotate relative to the housing assembly 100.

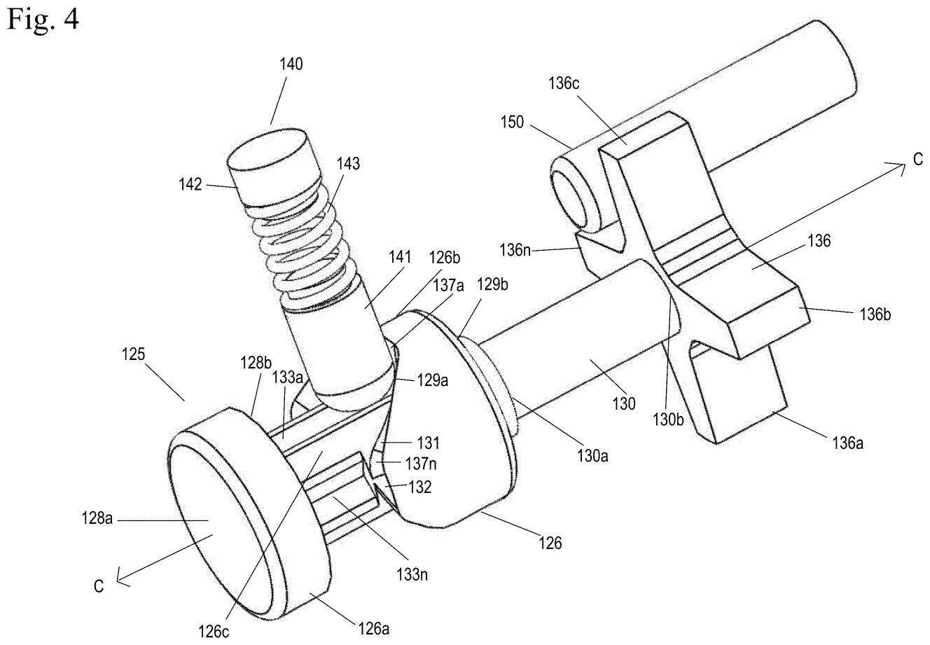

The lock pin 125 has a body 126 with a first closed head end 126a, a second end 126b and a recessed portion 126c between the first closed head end 126a and the second end 126b. The first closed head end 126a has a first surface 128a which can mate with the recess 127 and a second surface 128b which is adjacent the recessed portion 126c. The second end 126b of the body 126 of the lock pin 125 has a first surface 129a adjacent the recessed portion 126c and a second surface 129b which receives a shaft 130. The first surface 129a of the second end 126b has a first radiused edge 131 and a second radiused edge 132 with flats 137a-137n. Travel distance of the lock pin 125 is defined between a first set of flats 137a to the second set of flats 137b with the first and second radiused edges 131, 132 between the first and second set of flats 137a-137b. The recessed portion 126c is therefore defined between the second surface 128b of the closed head end 126a and the first surface 129a of the second end 126b. The recessed portion 126c additionally contains two or more detent grooves 133a-133n which run axially relative to a centerline C-C as shown in FIGS. 4, 7, 10, and 14. The flats 137a-137n are aligned with a detent groove 133a-133n. Adjacent detent grooves 133a-133n in the recessed portion 126c correspond to a locked position of the lock pin 125 and an unlocked position of the lock pin 125. The sequence around the radiused edge includes a repeat of a first radiused edge 131, a second radiused edge 132, a flat 137a-137n, a second radiused edge 132 and a first radiused edge 131.

A pin 140 having a first end 141 is spring 143 biased into contact with at least one of the detent grooves 133a-133n of the recessed portion 126c so that the pin 140 is perpendicular to the centerline C-C. The pin 140 is received within a recess 173 in the vane 104 and is perpendicular to the lock pin body 126. A plug 142 maintains the spring biased pin 140 in the recess 173. The force of spring 143 is tuned such that the pin 140 can be moved between the detent grooves 133a-133n and control overshoot of the lock pin rotation about the centerline C-C. The placement of the detent grooves 133a-133n additionally ensures that the lock pin 125 does not rotate once it is moved to the new position (locked or unlocked).

The shaft 130 has a first end 130a connected to the second surface 129b of the second end 126b of the lock pin body 126 and a second end 130b connected to a gear 136. The shaft 130 is received by and protrudes from a slot 147 of the second end plate 100b.

The gear or lever 136 has a plurality of radially extending teeth 136a-136n. The teeth 136a-136n are spaced apart relative to each other to allow a solenoid pin 150 to seat between the teeth 136a-136n. The number of teeth 136a-13n of the gear 136 corresponds to the number of detent grooves 133a-133n. A detent groove 133a-133n is present for each position and the number of positions is dictated by the number of teeth 136a-136n on the gear 136. The solenoid pin 150 position is stationary relative to the rotation of the phaser in the clockwise direction indicated by the arrow in FIGS. 1-3. The position of the solenoid pin 150 relative to interfacing with the teeth 136a-136n of the gear 136 is controlled by a solenoid 175. The solenoid 175 is preferably an on/off linear solenoid.

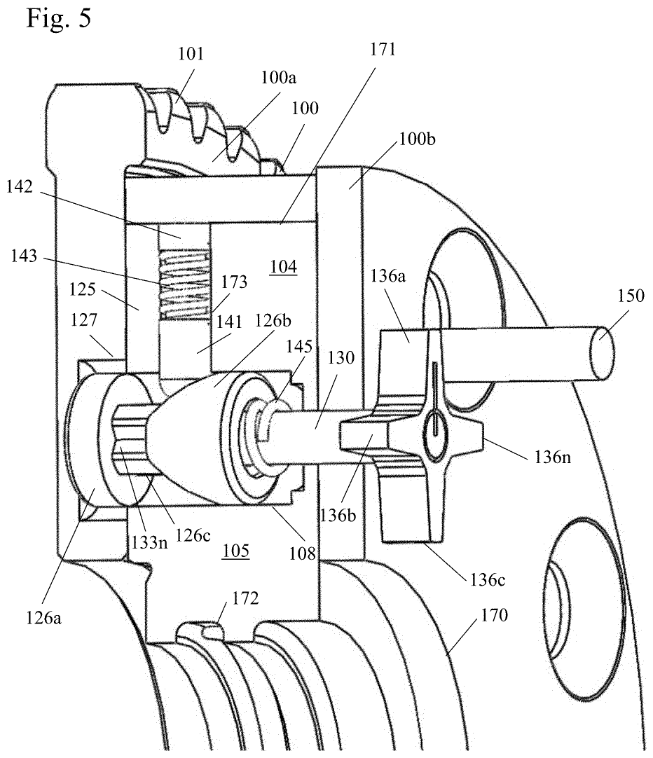

Adjacent the second surface 129b of the second end 126b of the lock pin body 126 is a lock pin spring 145 for biasing the first closed head end 126a of the lock pin 125 towards the recess 127 in the first end plate 100a of the housing assembly 100 as shown in FIGS. 5, 6, 8, 9, and 11-13.

In an alternate embodiment, a ramp could be used to return the solenoid pin 150 to the retracted position if a latching solenoid were used. The ramp ensures that the solenoid pin 150 is retracted within a single phaser rotation. If ramp is not present, the lock pin 125 is rotated again and returned to the previous lock/unlock position.

Referring to FIGS. 1 and 4-6, which shows the lock pin 125 in a locked position. In this position, the lock pin 125 interfaces with the recess 127 of the housing assembly 100 and the rotor assembly 105 is prevented from rotating relative to the housing assembly 100.

The housing assembly 100 of the phaser rotates in a clockwise direction as shown by the arrow as it is driven by the chain or belt. It should be noted that in the Figures, all elements except for the solenoid pin 150 of the solenoid 175 rotate with the phaser.

During the full rotation of the phaser 360°, the solenoid pin 150 of the linear solenoid 175 interfaces with gear tooth 136a of the gear 136, causing the gear 136 to turn counterclockwise. It should be noted that the solenoid pin 150 interacts with the gear 136 only once during 360° or full rotation of the phaser.

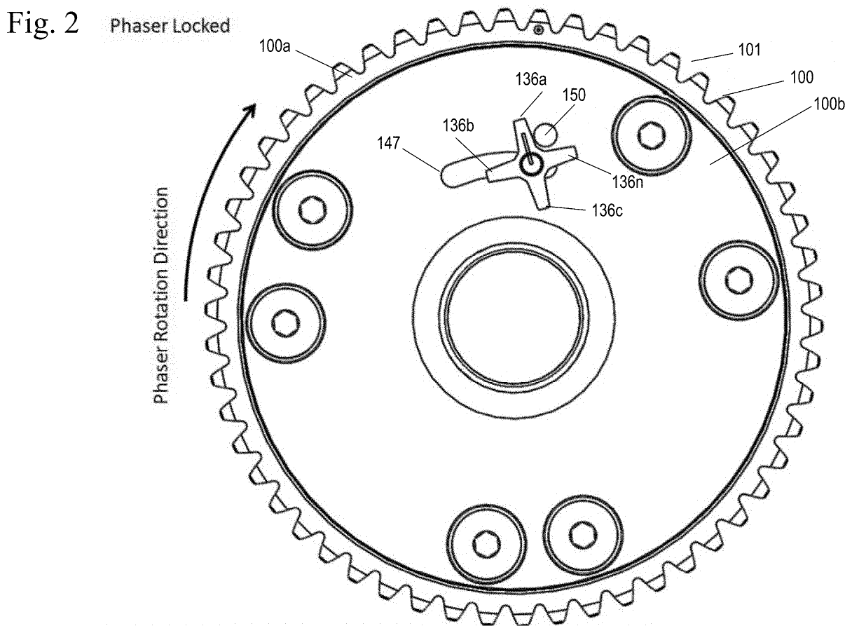

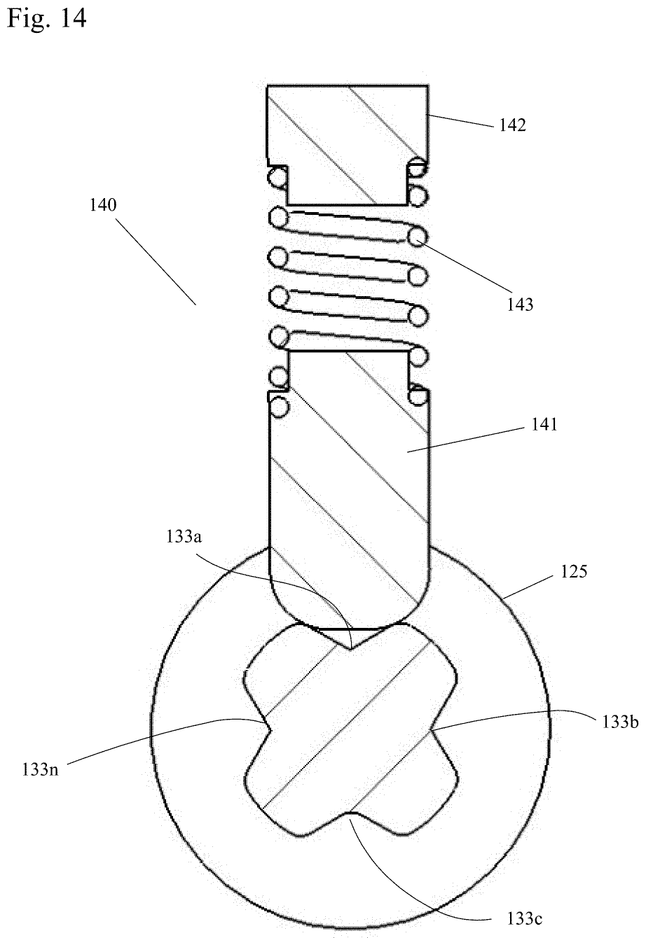

Referring to FIGS. 2 and 10-12, the rotation of the gear 136 is translated through the shaft 130 to the lock pin body 126, causing the lock pin body 126 to rotate in the counterclockwise direction 90° per full rotation (360°) of the housing assembly 100. The rotation of the lock pin body 126 causes the spring biased pin 140 to travel between detent grooves 133a-133n at each of the 90° rotation increments (see FIG. 14) along the first and second radiused edges 131, 132 of the first surface 129a of the second end 126b of the body until the spring biased pin 140 interfaces with the flats 137a-137n of the first surface 129a adjacent the detent groove 133a-133n, causing the spring biased pin 140 to seat in the detent groove 133a-133n, limiting the rotation of the lock pin 125. In the unlocked position, the closed head end 126a of the lock pin 125 does not interface with the recess 127 and the rotor assembly 105 can rotate relative to the housing assembly 100.

It should be noted that while the detent grooves 133a-133n are described as being 90° apart within the recessed portion 126c of the lock pin body 126, the spacing between the detent grooves 133a-133n can be altered.

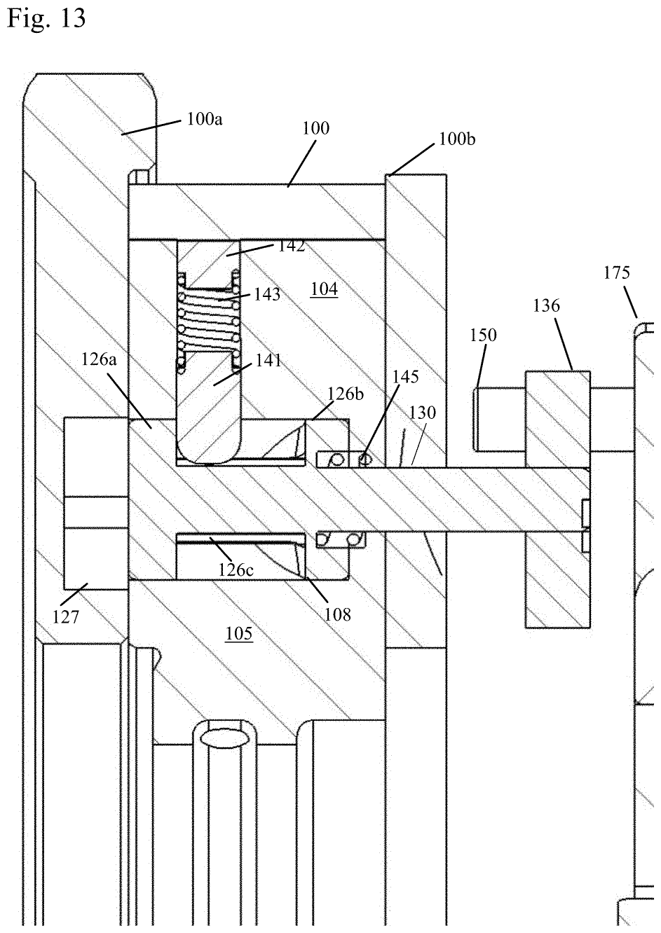

FIG. 13 shows a sectional of the phaser just prior to moving towards a locked position.

The spring biased pin 140 is seated in a detent groove 133a-133n of the recessed portion 126c of the lock pin body 126 of the lock pin 125. The pin 140 is adjacent the second surface 128b of the closed head end 126a of the lock pin body 126 of the lock pin 125 and not the first surface 129a of the second end 126b of the lock pin body 126.

FIGS. 2 and 10-12 show the lock pin 125 just prior to unlock (e.g. prior to fully disengaging from the recess 127 of the housing assembly 100) and between the locked and unlocked position.

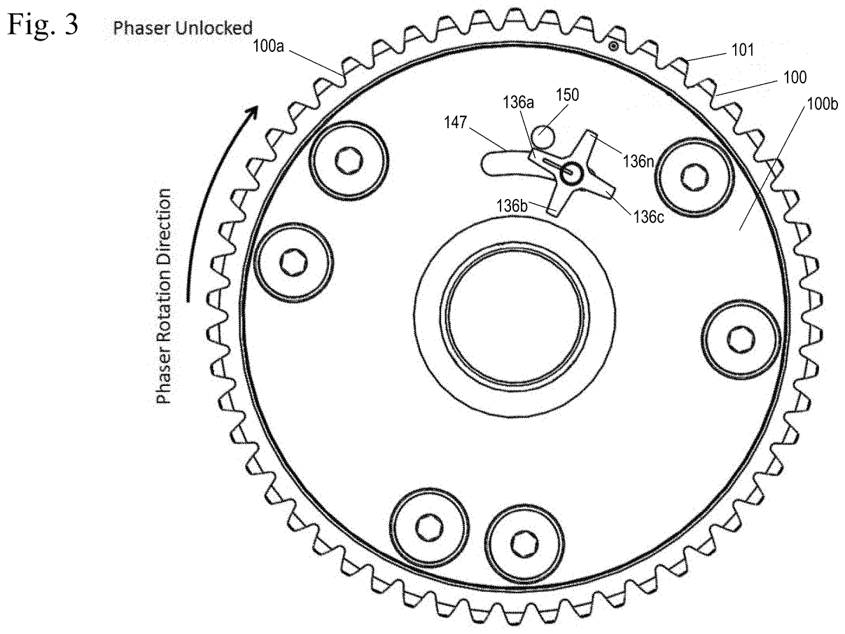

Referring to FIGS. 3 and 7-9, where the lock pin 125 is in an unlocked position, and during the full rotation of the phaser 360°, the solenoid pin 150 is adjacent and in contact with a single tooth. The contact of the solenoid pin 150 with the single gear tooth 136a rotates the lock pin body 126, such that the spring biased pin 140 is unseated from any detent groove 133a-133n it may have been seated in and the spring biased pin 140 is forced to travel along the first and second radiused edges 131, 132 of the first surface 129a of the second end 126b of the lock pin body 126. The travel of the spring biased pin 140 along the first and second radiused edges 131, 132 moves the lock pin 125 axially away from the recess 127 of the housing assembly 100.

FIGS. 1 and 4-6 shows the lock pin 125 in a locked position. In the locked position, the housing assembly 100 is fixed relative to the rotor assembly 105 and the phaser rotates in the clockwise direction as indicated by the arrow. During the full rotation of the phaser 360°, the solenoid pin 150 of the linear solenoid 175 interfaces with the gear tooth 136a of the gear 136, causing the gear 136 to turn counterclockwise. The rotation of the gear 136 is translated through the shaft 130 to the lock pin body 126, causing the lock pin body 126 to rotate in the counterclockwise direction 90° per full rotation (360°) of the housing assembly 100. The rotation of the lock pin body 126 causes the spring biased pin 140 to travel between detent groove 133n to detent groove 133a at each of the 90° rotation increments (see FIG. 14) along the first and second radiused edges 131, 132 of the first surface 129a of the second end 126b of the body until the pin 140 interfaces with the flat 137a of the first surface 129a adjacent the detent groove 133a, causing the pin 140 to seat in the detent groove 133a, limiting the rotation of the lock pin 125. In the locked position, the closed head end 126a of the lock pin interfaces with the recess 127 and the rotor assembly 105 cannot rotate relative to the housing assembly 100.

Therefore, in a locked position of the lock pin 125, spring bias pin 140 is in detent groove 133a and interfaces with flat 137a of the first surface 129a. In an unlocked position of the lock pin 125, spring bias pin 140 is in detent groove 133n and interfaces with flat 137n of the first surface 129a.

Between the locked and unlocked positions of the lock pin 125, spring bias pin 140 moves between detent grooves 133n and 133a along the first surface 129a.

Upon the next commanded lock pin change, the following detent grooves 133b, 133c would be used and 133a, 133b, 133c, 133n are used sequentially as locked or unlocked commands are received and the lock pin 125 will continue to rotate such that the detent grooves 133n and 133a are used for the next commanded lock pin change.

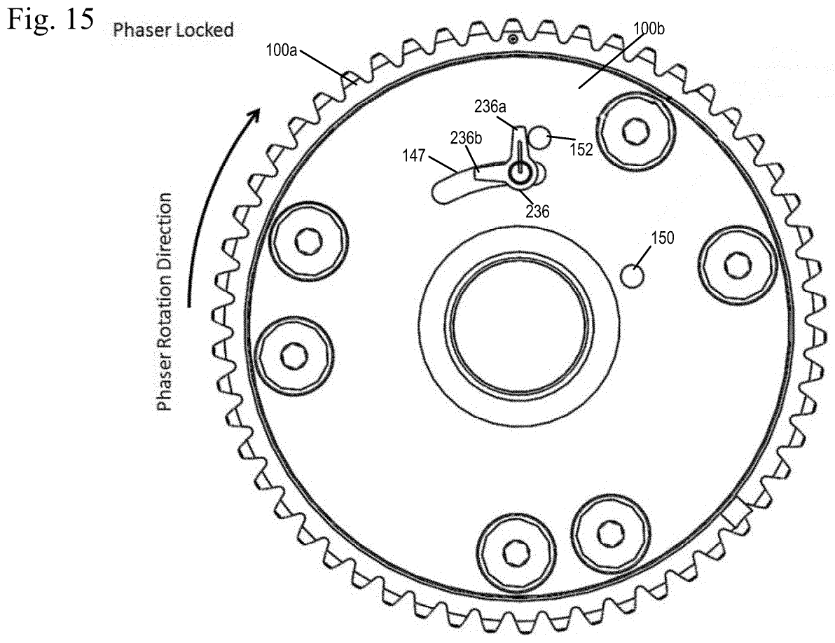

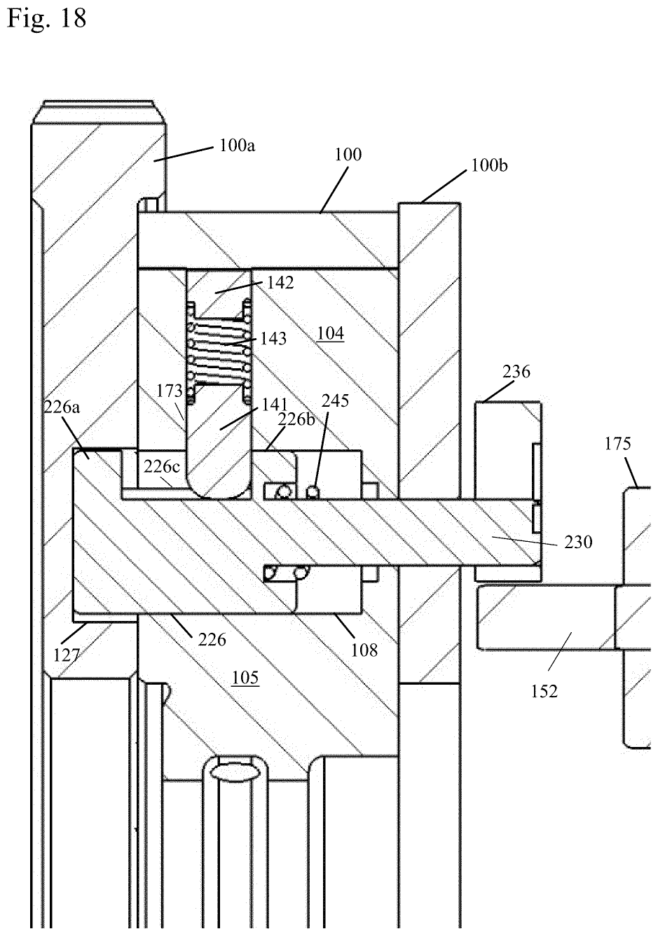

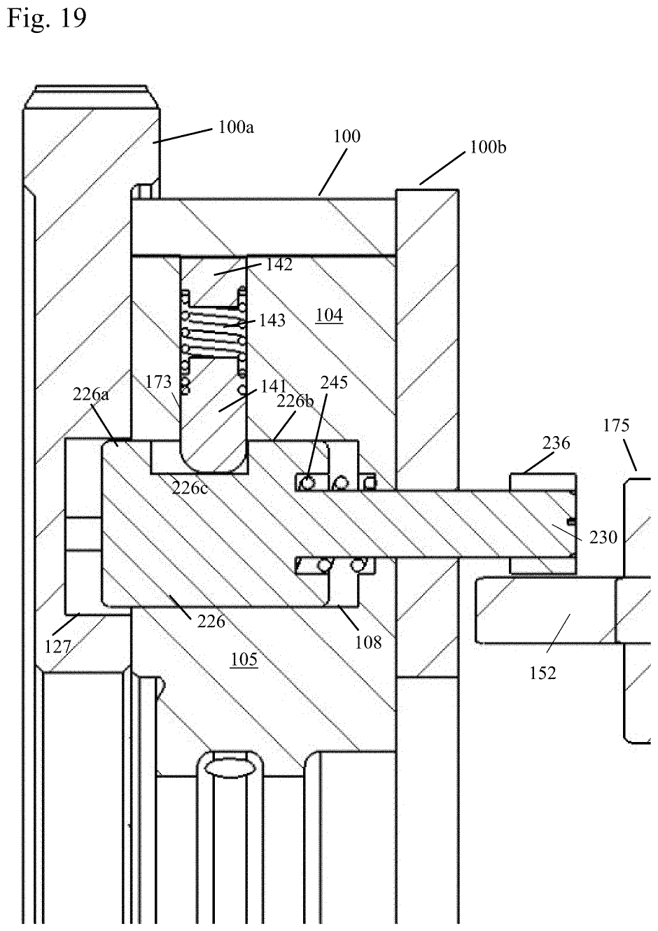

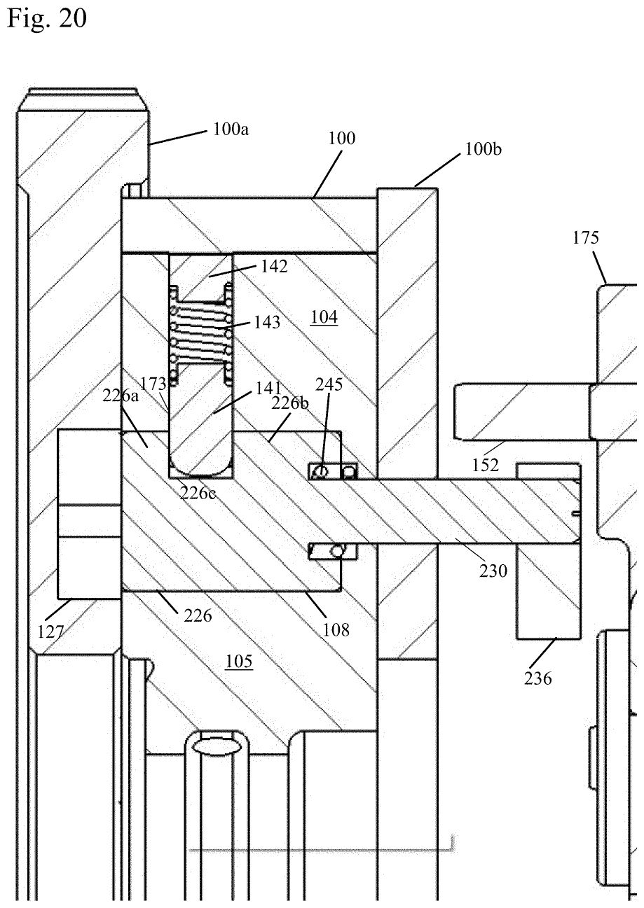

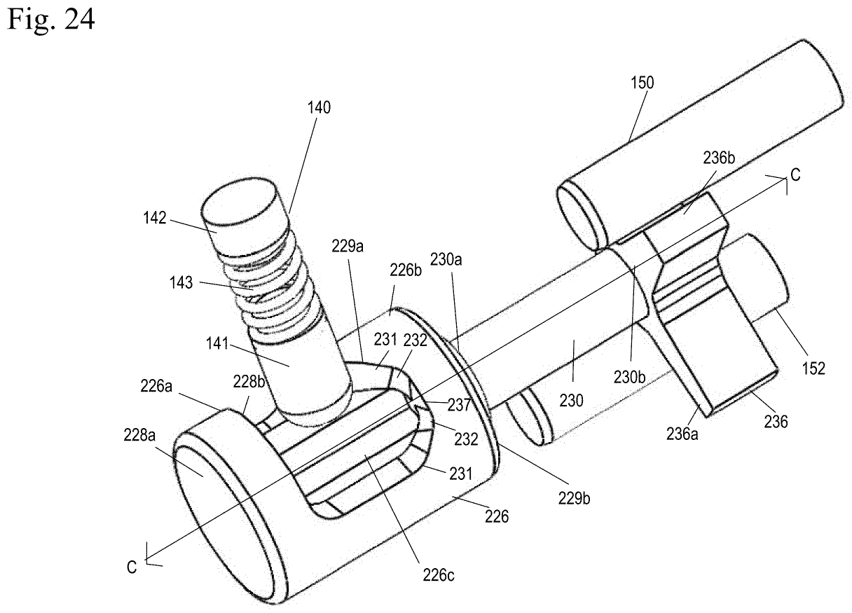

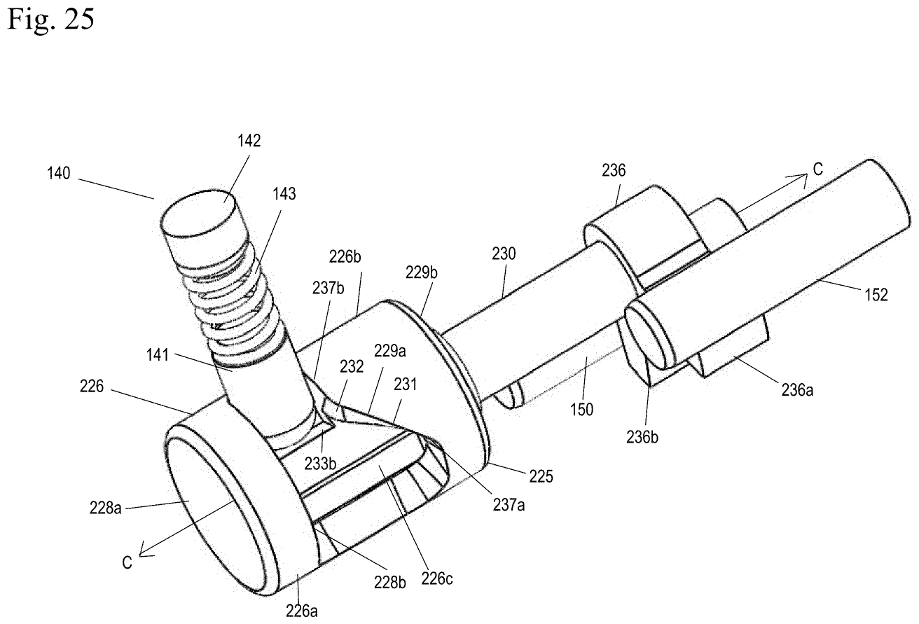

FIGS. 15-28 show an alternate embodiment in which two solenoid pins are present to engage a lock pin 225 use to lock the vane phaser.

Within at least one vane 104 of the rotor assembly 105 is a lock pin 225. The lock pin 225 is slidably housed in a bore 108 of the vane 104 of the rotor assembly 105. The lock pin 225 is moveable from a first locked position in which the lock pin 225 engages a recess 127 in a first end plate 100a of the housing assembly, preventing movement of the rotor assembly 105 relative to the housing assembly 100 and an unlocked position in which the lock pin 225 does not engage the recess 127 in the first end plate 100a of the housing assembly 100, and the rotor assembly 105 can rotate relative to the housing assembly 100.

The lock pin 225 has a body 226 with a first closed head end 226a, a second end 226b and a recessed portion 226c between the first closed head end 226a and the second end 226b. The first closed head end 226a has a first surface 228a which can mate with the recess 127 and a second surface 228b which is adjacent the recessed portion 226c. The second end 226b of the body 226 of the lock pin 225 has a first surface 229a adjacent the recessed portion 226c and a second surface 229b which receives a shaft 230.

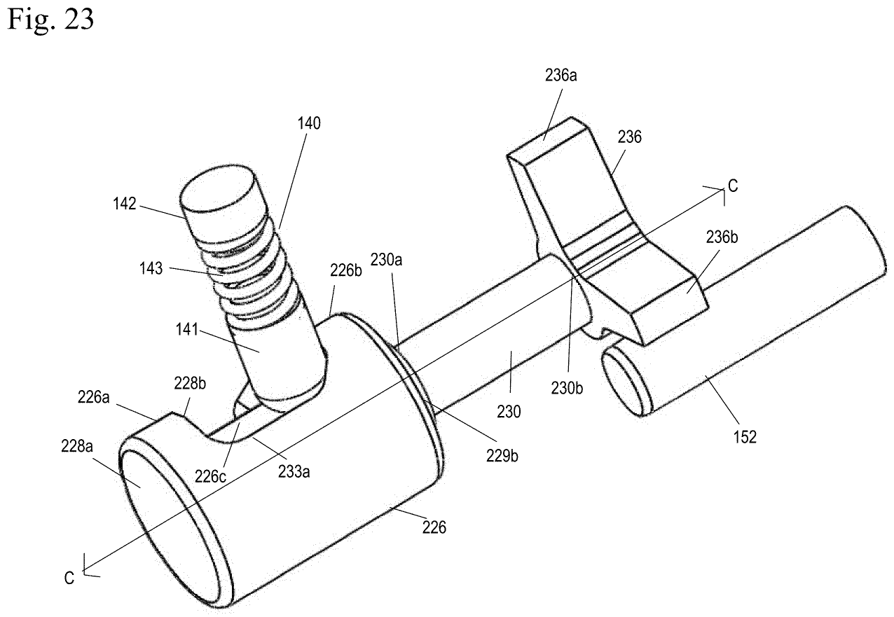

The first surface 229a of the second end 226b has at least two sequences of a first radiused edge 231, a second radiused edge 232 and a flat 237 that define travel distance of the lock pin 225. The recessed portion 226c is therefore defined between the second surface 228b of the closed head end 226a and the first surface 229a of the second end 226b. The recessed portion 226c additionally contains two detent grooves 233a, 233b which run axially relative to a centerline C-C as shown in FIGS. 23-26. The first detent groove 233a corresponds to a locked position of the lock pin 225 and the second detent groove 233b corresponds to an unlocked position of the lock pin 225. The flats 237 are aligned with detent grooves 233a, 233b. Therefore, a first flat 237a is aligned with detent groove 233a and a second flat 237b is aligned with detent groove 233b.

A pin 140 having a first end 141 and a spring 143 are received within a bore 173 of the vane 104 of the rotor assembly 105. The pin 140 is spring biased into contact with the recessed portion 226c of the lock pin 225 so that the pin 140 is perpendicular to the centerline C-C. A plug 142 maintains the spring biased pin 140 in the recess 173. The force of spring 143 is tuned such that the pin 140 can be moved between the detent grooves 233a, 233b and control overshoot of the lock pin 225 rotation about the centerline C-C. The placement of the detent grooves 233a-233b additionally ensures that the lock pin 225 does not rotate once it is moved to the new position (locked or unlocked). Adjacent the second surface 229b of the second end 226b of the lock pin body 226 is a lock pin spring 245 for biasing the first closed head end 228a of the lock pin 225 towards the recess 127 in the first end plate 100a of the housing assembly 100.

A shaft 230 has a first end 230a connected to the second surface 229b of the second end 226b of the lock pin body 226 and a second end 230b connected to a gear 236. The shaft 230 is received by and protrudes from a slot 147 of the second end plate 100b.

The gear or lever 236 has at least two radially extending teeth 236a, 236b. The teeth 236a, 236b are spaced apart relative to each other to allow first and second solenoid pins 150, 152 to interact with the teeth 236a, 236b. The position of the first and second solenoid pins 150, 152 is stationary relative to the rotation of the vane phaser in the clockwise direction indicated by the arrow in FIGS. 15-17. The position of the first and second solenoid pins 150, 152 relative to interfacing with the teeth 236a, 236b of the gear 236 is controlled by a solenoid 175. The first and second solenoids controlling the first and second solenoid pins 150, 152 are preferably on/off linear solenoids 175.

The spacing of the first and second solenoid pins 150, 152 relative to each other can be set based on the application and is irrelevant as long as both solenoid pins 150, 152 do not interact with both teeth 236a, 236b of the gear 236 at the same time.

In an alternate embodiment, a ramp could be used to return at least one of the solenoid pins 150, 152 to the retracted position if a latching solenoid were used. The ramp ensures that at least one of the solenoid pins 150, 152 is retracted from interaction with the gear teeth 236a, 236b of the gear 236 in preparation for the second solenoid pin 152 to be extended. If the ramp is not present and the first solenoid pin 150 is still extended when the second solenoid pin 152 extends, the lock pin 225 is rotated again and returned to the previous lock/unlock position.

Referring to FIGS. 15, 18 and 23, the lock pin 225 is in a locked position. The housing assembly 100 of the phaser rotates in a clockwise direction as shown by the arrow as it is driven by the chain or belt. In the locked position, the closed head end 226a of the lock pin 225 interfaces with the recess 127 and the rotor assembly 105 cannot rotate relative to the housing assembly 100.

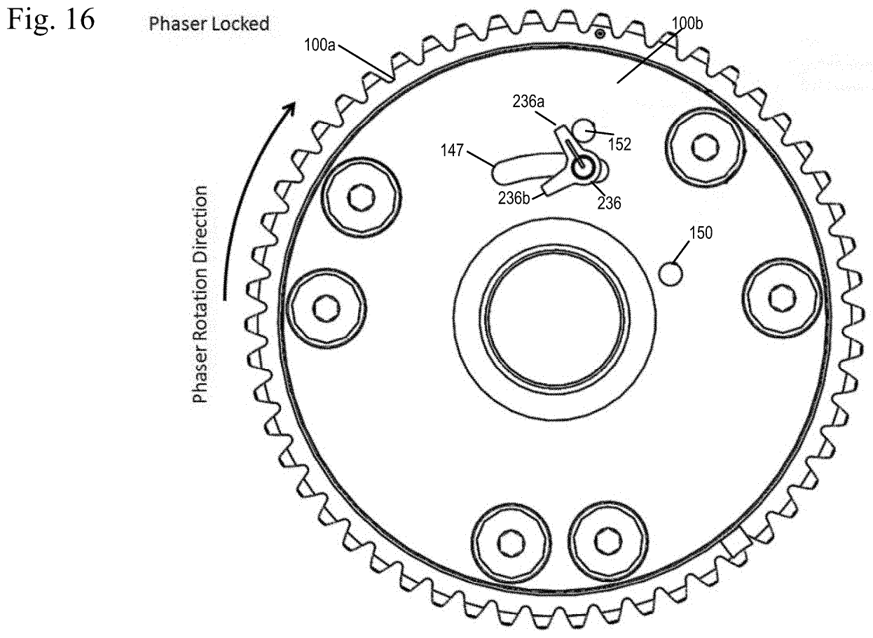

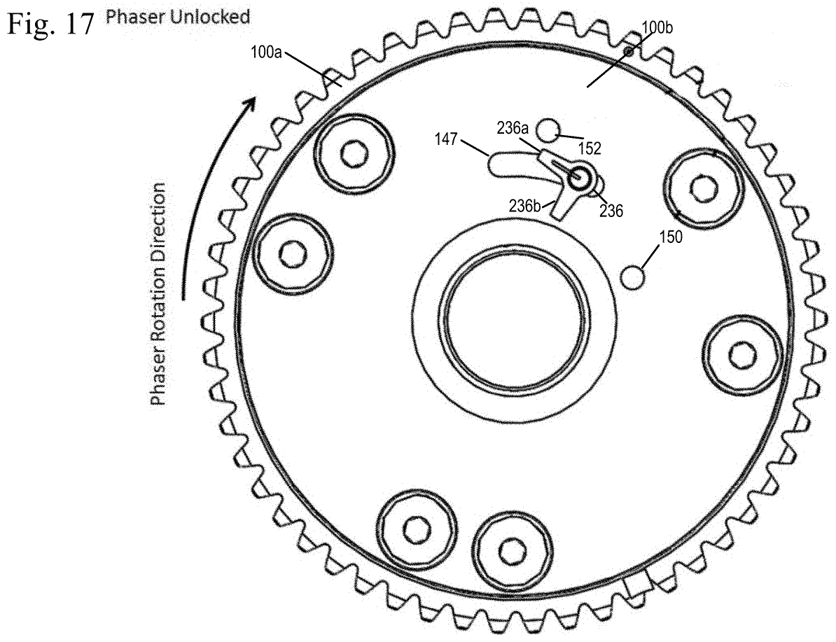

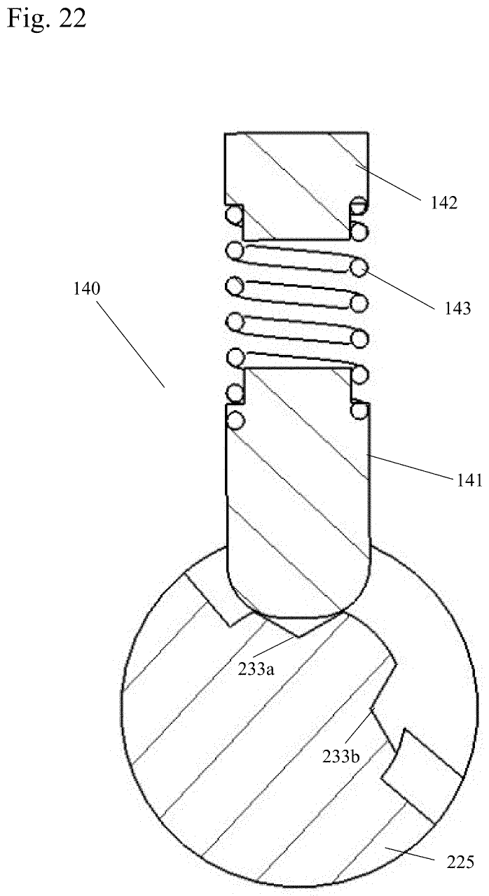

Referring to FIGS. 16, 19 and 24, the second solenoid pin 152 contacts the gear tooth 236a. The contact of the second solenoid pin 152 with the gear tooth 236a begins to rotate the lock pin body 226 counterclockwise. The rotation of the gear 236 is translated through the shaft 230 to the lock pin body 226, causing the lock pin body 226 to rotate in the counterclockwise direction 90° per full rotation (360°) of the housing assembly 100. The rotation of the lock pin body 226 causes the spring biased pin 140 to travel between detent grooves 233a and 233b (see FIG. 22) and more specifically, from the detent groove 233a along the first radiused edge 231 and the second radiused edge 232 of the first surface 229a of the second end 226b of the body until the pin 140 interfaces with the flat 237b of the first surface 229a adjacent the detent groove 233b, causing the spring biased pin 140 to seat in the detent groove 233b, limiting the rotation of the lock pin 225. The travel of the pin 140 along the first radiused edge 231 and the second radiused edge 232 moves the lock pin axially away from the recess 127 of the housing assembly 100. Referring to FIGS. 17, 20 and 25, the lock pin 225 has completed the 90° counterclockwise rotation and the phaser is in the unlocked position. In the unlocked position, the closed head end 226a of the lock pin 225 does not interface with the recess 127 and the rotor assembly 105 can rotate relative to the housing assembly 100.

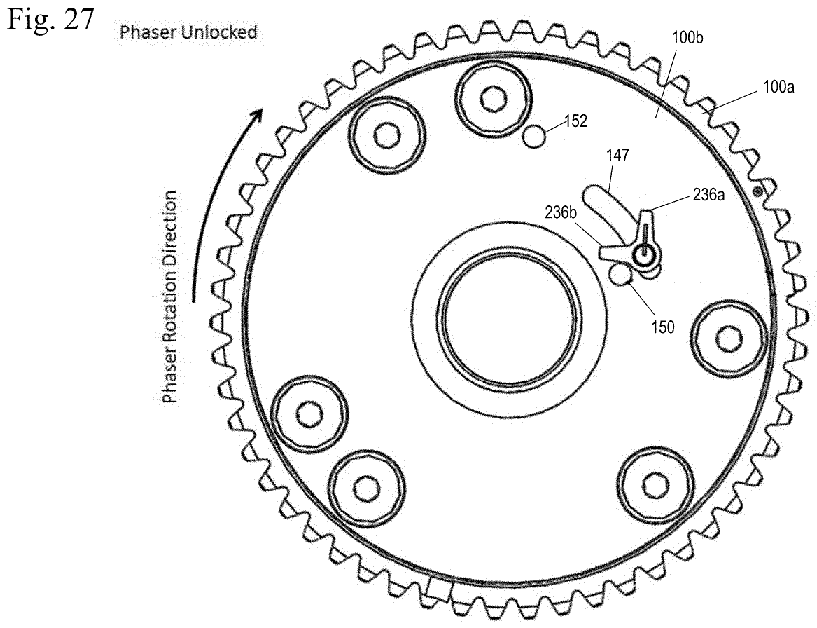

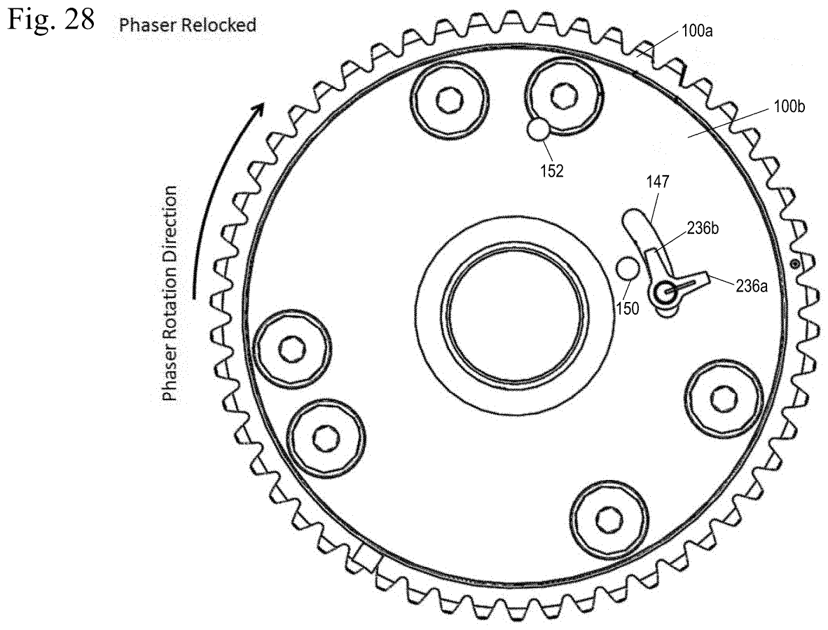

FIGS. 27 and 28 show the lock pin 225 starting in an unlocked position and moving back towards the locked position. During the full rotation of the phaser 360°, the first solenoid pin 150 of the first linear solenoid interfaces with the gear tooth 236b of the gear 236, causing the gear 236 to turn clockwise. The rotation of the gear 236 is translated through the shaft 230 to the lock pin body 226, causing the lock pin body 226 to rotate in the clockwise direction 90° per full rotation (360°) of the housing assembly 100. If the rotor assembly 105 is positioned so that the lock pin 225 is in line with the recess 127, the rotation of the lock pin body 226 causes the spring biased pin 140 to travel from the second detent groove 233b along the first radiused edge 231 and the second radiused edge 232 of the first surface 229a of the second end 226b of the body until the pin 140 interfaces with the flat 237a of the first surface 229a adjacent the first detent groove 233a, causing the pin 140 to seat in the first detent groove 233a, limiting the rotation of the lock pin 225. In the locked position, the closed head end 226a of the lock pin 225 interfaces with the recess 127 and the rotor assembly 105 cannot rotate relative to the housing assembly 100.

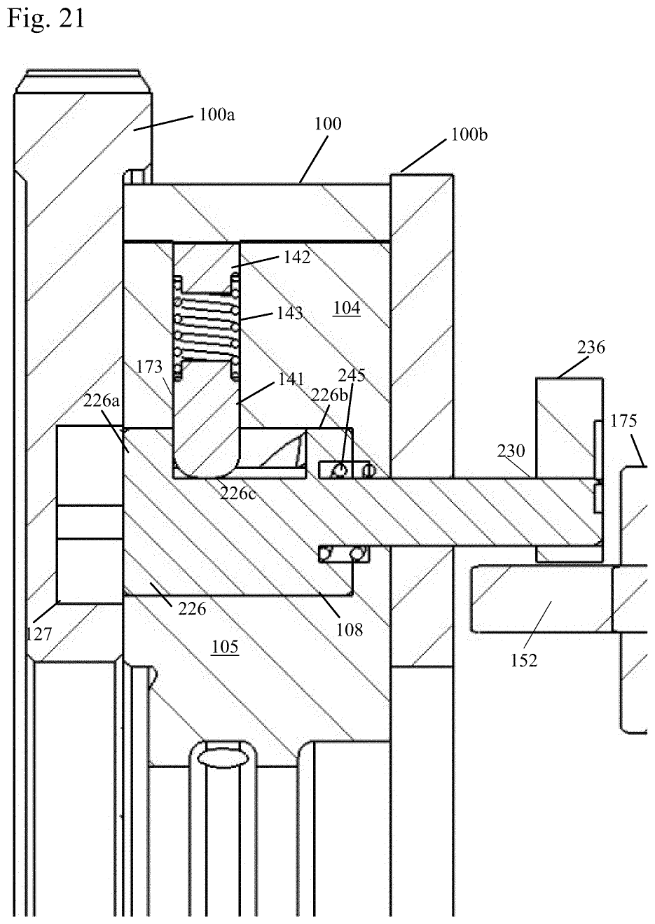

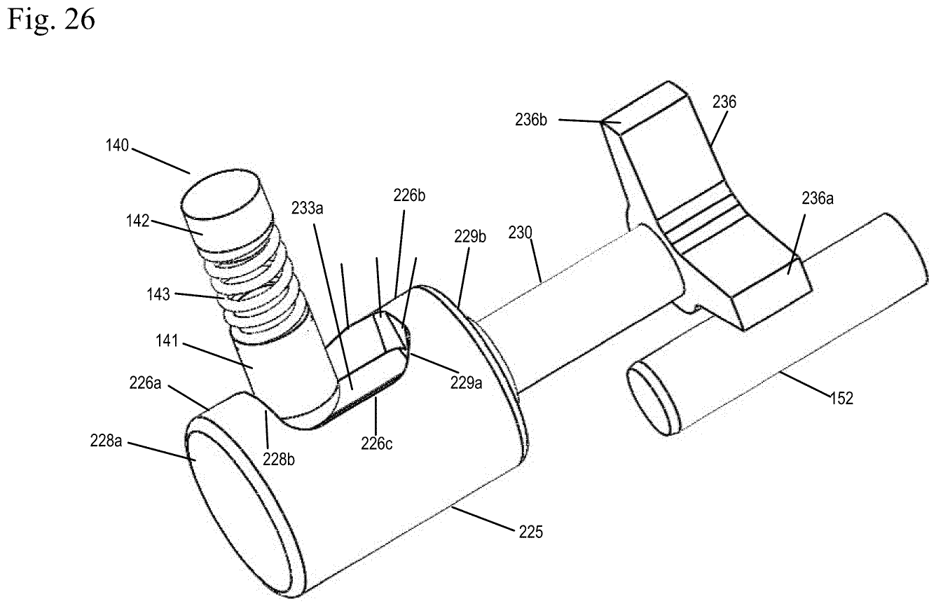

If the lock pin is rotated to the locked position before the rotor assembly 105 has moved to align the lock pin 225 with the recess 127 and no axial motion of the lock pin 225 is possible, the rotation of the lock pin body 226 causes the spring biased pin 140 to travel from the second detent groove 233b along the flat face 275 of the second surface 228b of the first end 226a of the body until the spring biased pin 140 seats in the first detent groove 233a, limiting the rotation of the lock pin 225. FIGS. 21 and 26 show a sectional of the phaser just prior to moving towards a locked position (prelock) and an isometric view of the lock pin 225. The spring biased pin 140 is seated in the detent groove 233a of the recessed portion 226c of the body 226 of the lock pin 225. The spring biased pin 140 is adjacent the second surface 228b of the closed head end 226a of the body 226 of the lock pin 225 and not the first surface 229a of the second end 226b of the body 226. Once the rotor assembly 105 has moved to align the lock pin 225 with the recess 127, the spring 245 will move the closed head end 226a of the lock pin 225 to interface with the recess 127 and the rotor assembly 105 will not be able to rotate relative to the housing assembly 100.

It should be noted that while the first and second detent grooves 233a, 233b are described as being 90° apart within the recessed portion 226c of the lock pin body 226, the spacing between the detent grooves 233a, 233b can be altered.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A vane phaser comprising:
a housing assembly;
a rotor assembly having at least one vane received within the housing assembly;
a lock pin received within a bore of the at least one vane of the rotor assembly, moveable between a locked position in which the lock pin engages a recess of the housing assembly and an unlocked position in which the lock pin does not engage the recess of the housing assembly, the lock pin comprising:
a body having a first closed head end, a second end and a recessed portion between the first closed head end and the second end,
wherein:
the first closed head end has a first surface for mating with the recess of the housing assembly, and a second surface adjacent the recessed portion;
the second end of the body has a first surface adjacent the recessed portion and a second surface, the first surface of the second end of the body comprising at least two repeats of a sequence of a first radiused edge, a flat, and a second radiused edge; and
the recessed portion is defined between the second surface of the first closed and the first surface of the second end of the body and has at least a first axially extending groove and a second axially extending groove, the first and second axially extending grooves each aligned with the flats of the first surface of the second end of the body;
a shaft having a first end and a second end, the first end attached to the second surface of the second end of the body and a second end connected to a gear having at least one tooth;
a spring surrounding the shaft and adjacent the second surface of the second end of the body for biasing the first closed head end towards the recess of the housing assembly;
a pin received within a bore of the rotor assembly and perpendicular to the body of the lock pin, having a first end spring biased towards the at least two axially extending grooves in the recessed portion; and
a solenoid having at least one solenoid pin engaging the at least one tooth of the gear;
wherein in the locked position of the lock pin, the first end of the pin sits in the first axially extending groove, such that the first end of the pin is adjacent the flat and the second surface of the first closed head end of the body;
wherein in the unlocked position of the lock pin, the first end of the pin sits in the second axially extending groove adjacent the second surface of the first closed head end of the body.

2. The vane phaser of claim 1, wherein the second end of the shaft extends through a slot in the housing assembly and the gear is outside of the housing assembly.

3. The vane phaser of claim 1, wherein the solenoid has two pins which engage the gear.

4. The vane phaser of claim 1, wherein the recessed portion further comprises a third axially extending groove and a fourth axially extending groove, such that the first axially extending groove, the second axially extending groove, the third axially extending groove and the fourth axially extending groove are each separated by ninety degrees.

5. The vane phaser of claim 1, wherein the first axially extending groove and the second axially extending groove are separated by ninety degrees.

6. The vane phaser of claim 1, wherein the at least one solenoid pin engages the at least one tooth of the gear once during a full 360 degree rotation of the vane phaser.

7. The vane phaser of claim 1, wherein the at least one solenoid pin is stationary relative to the vane phaser.

8. The vane phaser of claim 1, wherein to move the lock pin from a locked position to an unlocked position, the at least one solenoid pin interfaces with the at least one tooth of the gear, turning the gear counterclockwise, rotating the shaft and the body ninety degrees per full rotation of the housing assembly, unseating the pin from the first axially extending groove, such that the pin travels from the flat, to the second radiused edge, to the first radiused edge and to another flat, adjacent the second axially extending groove, the rotation of the body of the lock pin moving the first closed end of the lock pin axially away from the recess in the housing assembly.

9. The vane phaser of claim 1, wherein to move the lock pin from an unlocked position to a locked position, the at least one solenoid pin interfaces with the at least one tooth of the gear, turning the gear counterclockwise, rotating the shaft and the body ninety degrees per full rotation of the housing assembly, unseating the pin from the second axially extending groove, such that the pin travels from the flat, to the second radiused edge, to the first radiused edge and to another flat, adjacent the first axially extending groove, the rotation of the body of the lock pin moving the first closed end of the lock pin axially toward from the recess in the housing assembly.

10. A lock pin assembly received within a rotor assembly or housing assembly of a vane phaser, the lock pin comprising:
a body having a first closed head end, a second end and a recessed portion between the first closed head end and the second end,
wherein:
the first closed head end has a first surface for mating with the recess of the housing assembly, and a second surface adjacent the recessed portion;
the second end of the body has a first surface adjacent the recessed portion and a second surface, the first surface of the second end of the body comprising at least two repeats of a sequence of a first radiused edge, a flat, and a second radiused edge; and
the recessed portion is defined between the second surface of the first closed and the first surface of the second end of the body and has at least a first axially extending groove and a second axially extending groove, the first and second axially extending grooves each aligned with the flats of the first surface of the second end of the body;
a shaft having a first end and a second end, the first end attached to the second surface of the second end of the body and a second end connected to a gear having at least one tooth;
a spring surrounding the shaft and adjacent the second surface of the second end of the body for biasing the first closed head end towards the recess of the housing assembly;
a pin having a first end spring biased towards the at least two axially extending grooves in the recessed portion, the pin being perpendicular to the body of the lock pin.

11. The lock pin assembly of claim 10, wherein the recessed portion further comprises a third axially extending groove and a fourth axially extending groove, such that the first axially extending groove, the second axially extending groove, the third axially extending groove and the fourth axially extending groove are each separated by ninety degrees.

12. The lock pin assembly of claim 10, wherein the first axially extending groove and the second axially extending groove are separated by ninety degrees.

13. A vane phaser comprising:
a housing assembly;
a rotor assembly having at least one vane received within the housing assembly;
a lock pin received within a bore of the at least one vane of the rotor assembly, moveable between a locked position in which the lock pin engages a recess of the housing assembly and an unlocked position in which the lock pin does not engage the recess of the housing assembly, the lock pin having a helical feature, an attached gear wheel, and being spring biased towards the recess of the housing assembly and the locked position; and
a solenoid having at least one solenoid pin engaging the attached gear wheel on the lock pin;
wherein when the solenoid is energized and during rotation of the vane phaser, the at least one solenoid pin contacts the attached gear wheel on the lock pin, causing the lock pin to rotate, such that the helical feature of the lock pin moves the lock pin axially, moving the lock pin to the unlocked position, unlocking the vane phaser.

14. The vane phaser of claim 13, wherein the solenoid is a separate solenoid from the solenoid used to control an oil control valve of the phaser.
